(19) United States
(12) Patent Application Publication
(10) Pub. No.: US 2004/0108814 A1
(43) Pub. Date: Jun. 10, 2004

(54) Arc tube for discharge bulb

(75) Inventors: Toshiaki Tsuda, Shizuoka (JP); Masaya Shido, Shizuoka (JP); Masao Kinoshita, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD

(21) Appl. No.: 10/656,336

(22) Filed: Sep. 8, 2003

(30) Foreign Application Priority Data
Sep. 11, 2002 (JP) P.2002-265360

(51) Int. Cl. H01J 17/16

(52) U.S. Cl. 313/634

(57) ABSTRACT

The invention is an arc tube for a discharge bulb in which both ends of a light emitting tube inserting electrode bars respectively are sealed and a closed space having the electrodes opposed to each other and filled with a light emitting substance together with a rare gas for starting is provided in the light emitting tube, the light emitting tube is constituted by translucent ceramics having an excellent heat resistance and durability which is formed almost cylindrically and a ratio d/L of an outside diameter d to a whole length L is set to range from 0.2 to 0.5, thereby reducing a size. Moreover, the parallel ray transmittance of the light emitting tube is set to be 20% or less and the whole ray transmittance of the light emitting tube 12 is set to be 85% or more. Consequently, the whole light emitting tube uniformly emits a light so that a bar-shaped light emitting section having neither a luminance unevenness nor a color unevenness is obtained. In use for a discharge bulb to be a light source for a reflection type lighting unit, light distribution control can easily be carried out depending on the shape of the reflecting surface of a reflector and a bright and white proper distributed light can be formed.

### BACKGROUND OF THE INVENTION

1. Technical Field to which the Invention Belongs

The present invention relates to an arc tube for a discharge bulb used as a light source for a lighting unit of an automobile or the like. More particularly, the invention relates to an arc tube for a discharge bulb comprising a light emitting tube formed using translucent ceramics.

2. Description of the Related Art

In a discharge bulb to be a light source for a lighting unit of a car, an arc tube body 1 having a shroud glass 4 welded integrally with an arc tube 2 to be a light emitting tube is assembled and integrated into an insulating plug (insulating base) 9 formed of a synthetic resin, as shown in FIG. 16. More specifically, the rear end side of the arc tube body 1 is held and fixed to the front side of the insulating plug 9 through metal fittings 5, and the front end side of the arc tube body 1 is supported by a lead support 6 to be a direct electrical path extended from the insulating plug 9.

As shown in FIG. 17, the arc tube 2 has such a structure that both ends of a glass tube are sealed to form a closed glass bulb 2a filled with a light emitting substance together with a rare gas for starting in a central part in the longitudinal direction of the glass tube and having electrodes 3 and 3 opposed to each other, and emits a light through a discharge between the opposed electrodes 3 and 3. The outer side surface of the cylindrical shroud glass 4 having a UV cut function which is integrated with the arc tube 2 is provided with a shielding film 7 for light distribution control. This serves to intercept a part of a light transmitted toward an effective reflecting surface 8a of a reflector 8 and to form a clear cut line.

A light source for a lighting unit of a car includes an incandescent bulb for red heating a filament to generate heat and a discharge bulb in which an arc generated by a discharge between electrodes generates a light. In the incandescent bulb, the whole filament emits a light almost uniformly so that a bar-shaped light-emitting section is obtained. In the case in which the incandescent bulb is used as a light source for a reflection type lighting unit, therefore, the light distribution control can easily be carried out depending on the shape of the reflecting surface of a reflector.

On the other hand, the discharge bulb has a larger light amount and a longer lifetime than those of the incandescent bulb, which is preferable. First of all, the central luminance of an arc is high and the luminance of the outer periphery (peripheral edge portion) of the arc is low. Therefore, the luminance gradient of the arc is great. If a cut line is to be formed by the arc itself, a glare light is generated. For this reason, it is necessary to provide the shielding film 7 for cut line formation on the shroud glass 4. Corresponding to shielding, the waste of a light is increased. Corresponding to the great luminance gradient, a luminous intensity unevenness is increased and a light distribution design is carried out with difficulty.

Secondly, an arc 3a generated between the electrodes 3 and 3 has such a shape as to be curved to be upward convexed (see FIG. 17), and the light distribution design is hard to perform. If the diameter of an arc tube is reduced to prevent this difficulty, the heat resistance and the durability of a quartz glass to be the material of the arc tube are limited so that a devitrification phenomenon, a reduction in a luminous flux, a change in a chromaticity, and furthermore, a crack and a rupture may be caused. For this reason, a closed space (discharge space) for filling the rare gas for starting at a high pressure and generating an arc is to have an almost spherical shape.

Accordingly, a reduction in the size of the arc tube is restricted, and it is hard to cause the arc of the arc tube to take the shape of a small bar in which the light distribution control can easily be carried out depending on the shape of the reflecting surface of a reflector such as the filament of an incandescent bulb. Moreover, a color separation is generated. That is, the color of the arc is varied depending on a distance from the center of the arc. For this reason, it is hard to emit a uniform white light by the light distribution control depending on the shape of the reflecting surface of the reflector.

Furthermore, a metal halide to be a light emitting substance is filled in the closed glass bulb 2a in an oversaturation state, which is not preferable in that a light Li emitted downward from the arc tube has a color (yellow) of an aqueous metal halide 2b accumulated in the bottom portion of the closed glass bulb 2a to form a white distributed light.

Therefore, the inventor gave attention to translucent ceramics having an excellent heat resistance and durability. More specifically, the inventor considered as follows. The ceramics are excellent in heat resistance and durability. Therefore, there is no problem in the heat resistance and the durability even if the light emitting tube is formed cylindrically to reduce the closed space. In addition, the arc generated between the electrodes takes such a shape as to conform to the cylindrical closed space, that is, the shape of a bar. Moreover, the translucent ceramics are milk-white and a surface thereof has the function of diffusing an emitted light and can be used as a light emitting section for uniformly emitting a light from the light emitting tube itself. As a result, the inventor proposed the present invention.

### SUMMARY OF THE INVENTION

The invention has been made based on the knowledge of the inventor in consideration of the problems of the prior art, and has a first object to provide a small-sized arc tube for a discharge bulb in which a light emitting tube is constituted cylindrically by translucent ceramics and a dimension ratio of an outside diameter to a length is specified to satisfy the initial performance and light distribution performance of a bulb. A second object is to provide an arc tube for a discharge bulb in which a light emitting tube is constituted cylindrically by translucent ceramics and a parallel ray transmittance and a whole ray transmittance are specified to easily carry out light distribution control depending on the shape of the reflecting surface of a reflector.

In order to achieve the objects, a first aspect of the invention is directed to an arc tube for a discharge bulb in which both ends of a light emitting tube inserting electrodes respectively are sealed and a closed space having the electrodes opposed to each other and filled with a light emitting substance with a rare gas for starting is provided in the light emitting tube, wherein the light emitting tube is constituted by translucent ceramics formed substantially cylindrically and has a ratio d/L of an outside diameter d to a whole length L ranging from 0.2 to 0.5.

(Function) The ceramics are excellent in a heat resistance and durability. Even if the whole light emitting tube is formed to have a small size and a comparatively elongated cylindrical shape, therefore, it causes neither a thermal deformation nor a thermal degradation.

More specifically, concerning the relationship between inside diameter of light emitting tube and whole luminous flux as shown in FIG. 3 (length L of light emitting tube fixed to 14.0 mm) and FIG. 6, in the case in which the light emitting tube is too thin, that is, has an inside diameter of 1.0 mm or less (an outer diameter is less than 1.5 mm), a stable luminous flux of 2000 lumens or more is not discharged. In order to obtain the stable luminous flux of 2000 lumens or more, therefore, it is necessary to set the inside diameter of the light emitting tube to be 1.5 mm or more (the outside diameter to be 2.0 mm or more). On the other hand, if the light emitting tube is too thick (the outside diameter is 4.5 mm or more), a maximum illuminance in a distributed light is reduced and a maximum illuminance point position is also moved downward from the position of a horizontal line so that distance visibility is deteriorated. In order to prevent the maximum illuminance in the distributed light from being reduced, to hold the maximum illuminance point position in the vicinity of the position of the horizontal line and to maintain the distant visibility, consequently, it is necessary to set the outside diameter of the light emitting tube to be 4.0 mm or less. Accordingly, it is desirable that the outside diameter of the light emitting tube should be 2.0 to 4.0 mm, and preferably 2.5 to 3.5 mm.

Next, as for relationship between length L of light emitting tube and whole luminous flux such as shown in FIG. 4 (inside diameter of light emitting tube is fixed to 1.5 mm) and FIG. 6, moreover, the amount of a light distribution may be insufficient if the length of the light emitting tube is too small (4.0 mm or less), and the temperature of the coldest point of the base part of the electrode is reduced so that a light emission efficiency is decreased and a luminous flux of 2000 lumens or more cannot be obtained if the length of the light emitting tube is too great (16.0 mm or more). Accordingly, it is desirable that the length of the light emitting tube be in the range of 6.0 to 14.0 mm and preferably 8.0 to 12.0 mm.

When the size of the cylindrical light emitting tube is specified by a dimension ratio d/L of an outside diameter d to a whole length L, it is desirable that the d/L should range from 0.2 to 0.5 in order to obtain a stable luminous flux of 2000 lumens or more which has an excellent visibility.

Furthermore, a metal halide to be used as a light emitting substance is filled in the closed space of the light emitting tube. Ceramics rarely react to the filled substance differently from a glass, and it is possible to prevent a deterioration with the passage of time, for example, a devitrification phenomenon, a reduction in the luminous flux and a change in a chromaticity which are caused in related art arc tubes formed of glass.

In the case in which the closed space is formed to be elongated, moreover, an arc generated between the electrodes becomes straight in conformity to the cylindrical light emitting tube. The luminance and color of an arc are varied depending on a distance from the center of the arc. Since translucent ceramics are milk-white and have the function of diffusing an emitted light, the arc is transmitted through the milk-white light emitting tube so that differences in a luminance and a color are smoothened and the whole light emitting tube emits a light comparatively uniformly, thereby constituting a light emitting section in which a luminance unevenness and a color unevenness are not remarkable. By reducing the size of the light emitting tube, accordingly, it is also possible to form a distributed light having a predetermined cut line with such a structure that the arc tube is provided with a discharge center set in a predetermined position placed above the focal point of the effective reflecting surface of the reflector (without providing a shielding section for cut line formation on a shroud glass), for example.

Moreover, the metal halide filled in the light emitting tube is accumulated in the vicinity of the electrode (both ends of the light emitting tube) to be the coldest point position in the cylindrical light emitting tube, the light emitted from both ends of the light emitting tube are not utilized as a distributed light from the beginning, and the yellow light of the metal halide is diluted in transmission through the milk-white light emitting tube, and is diffused during emission and is thus unremarkable. Therefore, there is no problem in the light distribution.

Furthermore, the whole light emitting tube is cylindrical. As compared with related art arc tubes provided with a bulged spherical portion constituting a closed space on a central part in the longitudinal direction of the light emitting tube, therefore, the light emitting tube can be thinned corresponding to the bulged spherical portion. Consequently, the outside diameter of the shroud glass to be provided to cover the light emitting tube can be reduced correspondingly. In the case in which the shielding film for forming a distributed light is to be provided on the shroud glass, the shielding film approaches the light emitting tube to be the light emitting section. Correspondingly, a cut line in the distributed light can be clear. In the case in which the tubular diameter of the shroud glass is not changed, moreover, the shroud glass and the shielding film are less influenced by heat so that a variation in the selection of a material is increased corresponding to the separation of the shroud glass from the light emitting tube to be the light emitting section.

A second aspect of the invention is directed to the arc tube for a discharge bulb according to the first aspect of the invention, wherein the light emitting tube has a thickness of 0.25 mm to 1.2 mm.

The result of the above mentioned aspect can be identified in the relationship between thickness of light emitting tube and durability as shown in FIG. 5, if the thickness of the tubular wall of the light emitting tube is too small (0.20 mm or less) or too great (1.40 mm or more), a crack is generated on the tubular wall. Therefore, it is desirable that the thickness of the tubular wall of the light emitting tube should range from 0.25 to 1.20 mm in which a crack is not generated on the tubular wall.

A third aspect of the invention is directed to an arc tube for a discharge bulb in which both ends of a light emitting tube inserting electrodes respectively are sealed and a closed space having the electrodes opposed to each other and filled with a light emitting substance together with a rare gas for starting is provided in the light emitting tube, wherein the light emitting tube is constituted by translucent ceramics formed almost cylindrically and has a parallel ray transmittance of 20% or less and a whole ray transmittance of 85% or more.

(Function) There is obtained the following function in addition to the function acquired by constituting the light emitting tube by the almost cylindrical translucent ceramics described in the first aspect of the invention.

First of all, the whole ray transmittance of the light emitting tube is 85% or more. Therefore, a sufficient luminous flux can be obtained.

Secondly, the luminance and color of the arc are varied depending on the distance from the center of the arc. However, since the parallel ray transmittance of the light emitting tube is equal to or less than 20%, the translucent ceramics are milk-white, and furthermore, the function of diffusing an emitted light is great (a diffusion transmittance is high) and (the light of) the arc is transmitted through the milk-white light emitting tube so that differences in a brightness and a color are more smoothened and the whole light emitting tube emits a light more uniformly. Thus, a light emitting section having neither a luminance unevenness nor a color unevenness is constituted.

Moreover, the metal halide filled in the light emitting tube is accumulated in the vicinity of the electrode (both ends of the light emitting tube) to be the coldest point position in the cylindrical light emitting tube, and the yellow light of the metal halide is diluted in transmission through the milk-white light emitting tube, and is diffused during emission and is thus unremarkable. Therefore, there is no problem in the light distribution.

As shown in FIGS. 9 and 10, when the parallel ray transmittance of the light emitting tube exceeds 20%, the diffusion transmittance (whole ray transmittance−parallel ray transmittance) is correspondingly reduced and the luminance distribution of the position of the outer peripheral edge of the light emitting tube (indicated as P) is gentle (is not clear) so that the luminance unevenness and color unevenness of the arc are remarkable through the light emitting tube. On the other hand,as shown in FIGS. 11 and 12, if the parallel ray transmittance of the light emitting tube is equal to or less than 20%, the diffusion transmittance is correspondingly increased and the luminance distribution of the position of the outer peripheral edge of the light emitting tube (indicated as P) is sharp (clear) so that the luminance unevenness and color unevenness of the arc are not remarkable through the light emitting tube. For this reason, it is possible to form a clear cut line with such a structure that the arc tube is provided with the center of a discharge (the center of a luminance) set in a predetermined position placed above the focal point of the effective reflecting surface of the reflector, for example, without separately using shielding means for cut line formation such as a shielding film.

### BRIEF DESCRIPTION OF THE DRAWINGS

FIG. 1 is a longitudinal sectional view showing a discharge bulb using an arc tube according to a first embodiment of the invention;

FIG. 2 is a longitudinal sectional view showing the main part of the arc tube;

FIG. 3 is a table showing the relationship between the inside diameter of a light emitting tube and a whole luminous flux;

FIG. 4 is a table showing the relationship between the length of a light emitting tube and a whole luminous flux;

FIG. 5 is a table showing the result of a test for the thickness and durability of a light emitting tube;

FIG. 6 is a table showing the result of a test in which the influence of the length and outside diameter of a light emitting tube on the initial performance of a light source and the light distribution performance of a headlamp is inspected;

FIG. 7 is a longitudinal sectional view showing a discharge bulb using an arc tube according to a second embodiment of the invention;

FIG. 8 is a longitudinal sectional view showing the main part of the embodiment;

FIG. 9 is a chart showing a luminance distribution characteristic in a light emitting tube having a parallel ray transmittance of 90%;

FIG. 10 is a chart showing a luminance distribution characteristic in a light emitting tube having a parallel ray transmittance of 50%;

FIG. 11 is a chart showing a luminance distribution characteristic in a light emitting tube having a parallel ray transmittance of 20%;

FIG. 12 is a chart showing a luminance distribution characteristic in a light emitting tube having a parallel ray transmittance of 10%;

FIG. 13 is a longitudinal sectional view showing a main part according to a third embodiment of the invention;

FIG. 14(a) is a transverse sectional view showing an electrode (a sectional view taken along a line XIV-XIV illustrated in FIG. 13);

FIG. 14(b) is an exploded perspective view showing the electrode;

FIG. 15 is a side view showing a discharge bulb using an arc tube according to a fourth embodiment of the invention;

FIG. 16 is a longitudinal sectional view showing a related art discharge bulb; and

FIG. 17 is an enlarged longitudinal sectional view showing an arc tube.

### DETAILED DESCRIPTION OF THE INVENTION

Embodiments of the invention will be described below.

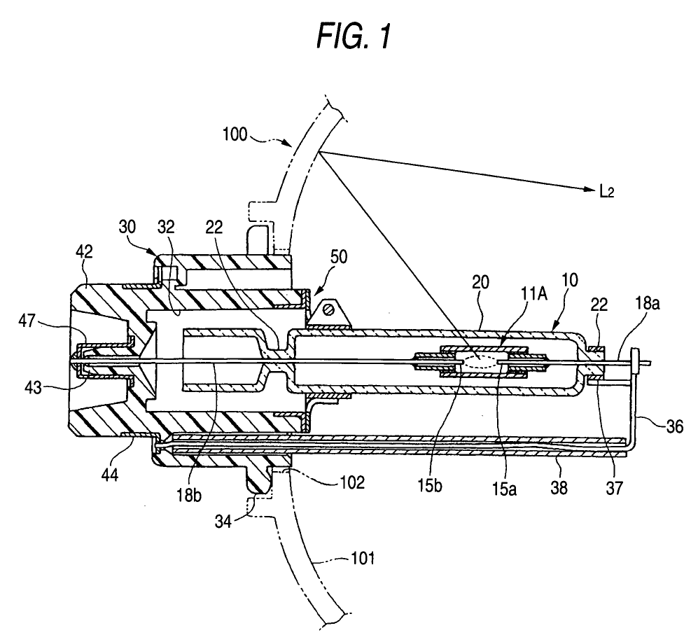

FIGS. 1 to 6 show a first embodiment of the invention.

In these drawings, the reference numeral 30 denotes an insulating plug formed of a PPS resin which has an outer periphery provided with a focal ring 34 engaged with a bulb insertion hole 102 of a reflector 100 of a headlamp for a car. An arc tube body 10 is fixed and supported by a metallic lead support 36 to be a direct electrical path extended forward from the plug 30 and a metallic support member 50 fixed to the front surface of the plug 30 in front of the insulating plug 30 and a discharge bulb is thus constituted.

More specifically, a lead wire 18a led from the front end of the arc tube body 10 is fixed to the bent tip portion of the lead support 36 extended from the insulating plug 30 by spot welding, and furthermore, the front end of the arc tube body 10 is carried on the bent tip portion of the lead support 36 through a metallic support member 37. On the other hand, a lead wire 18b led from the rear end of the arc tube body 10 is connected to a terminal 47 provided on the rear end of the insulating plug 30, and furthermore, the rear end of the arc tube body 10 is held by the metallic support member 50 fixed to the front surface of the insulating plug 30.

The front end of the insulating plug 30 is provided with a concave portion 32 and the rear end of the arc tube body 10 is accommodated and held in the concave portion 32. A cylindrical boss 43 surrounded by an outer cylindrical portion 42 extended rearward is formed on the rear end of the insulating plug 30, a cylindrical belt-shaped terminal 44 connected to the lead support 36 is fixed and integrated with the outer periphery of the base part of the outer cylindrical portion 42, and a cap type terminal 47 to which the lead wire 18b on the rear end side is connected is welded and integrated with the boss 43.

The arc tube body 10 has such a structure that a cylindrical shroud glass 20 for shielding ultraviolet rays is provided integrally to cover an arc tube 11A including a closed space 12a having electrodes 15a and 15b provided opposite to each other, and the lead wires 18a and 18b connected to the electrodes 15a and 15b in the closed space 12a are led from the front and rear ends of the arc tube 11A. The shroud glass 20 is pinch sealed (sealed) to the lead wires 18a and 18b so that both of them (the arc tube 11A and the shroud glass 20) are integrated. The reference numeral 22 denotes a pinch seal portion having a diameter reduced in the shroud glass 20.

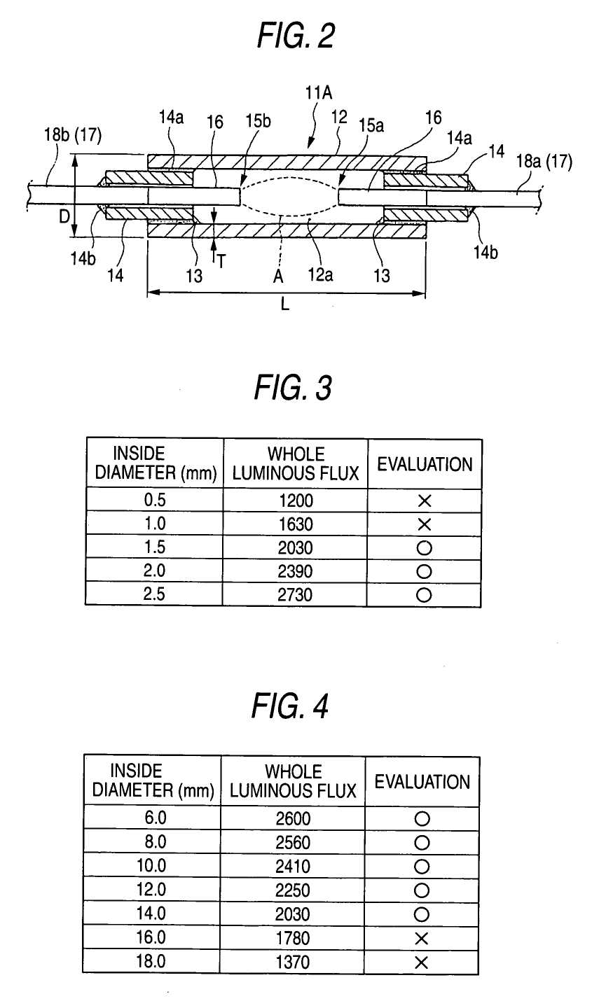

As shown in the enlarged view of FIG. 2, the arc tube 11A has such a structure that both ends of a light emitting tube 12 formed of translucent ceramics and taking the shape of a right cylinder are sealed and the closed space 12a having the electrodes 15a and 15b provided opposite to each other in the light emitting tube 12 and filled with a light emitting substance (mercury and a metal halide) together with a rare gas for starting is provided, and the lead wires 18a and 18b bonded to the electrodes 15a and 15b are led outward from the sealing portion of the light emitting tube 12 respectively. The light emitting tube 12 is constituted to have a very small size with an outside diameter of 2.0 to 4.0 mm, a length of 8.0 to 12.0 mm and a dimension ratio d/L of the outside diameter to the length L of 0.2 to 0.5. In this manner, heat resistance and durability are maintained, and furthermore, the whole arc tube 11A (light emitting tube 12) emits a light almost uniformly.

More specifically, FIGS. 3, 4, 5 and 6 show the relationship between the inside diameter of a light emitting tube and a whole luminous flux, the relationship between the length of the light emitting tube and the whole luminous flux, the relationship between the thickness of the light emitting tube and a durability, and the influence of the length and outside diameter of the light emitting tube on the initial performance of a light source and the light distribution performance of a headlamp. As shown in FIGS. 3 and 6, in the case in which the light emitting tube is too thin, that is, has an inside diameter of 1.0 mm or less (an outer diameter is less than 1.5 mm), a stable luminous flux of 2000 lumens or more is not discharged. In order to obtain the stable luminance flux of 2000 lumens or more, therefore, it is necessary to set the inside diameter of the light emitting tube to be 1.5 mm or more (the inside diameter to be 2.0 mm or more). On the other hand, if the light emitting tube is too thick (the outside diameter is 4.5 mm or more), a maximum illuminance in a distributed light is reduced and a maximum illuminance point position is also moved downward from the position of a horizontal line so that a distant visibility is deteriorated. In order to prevent the maximum illuminance in the distributed light from being reduced, to hold the maximum illuminance point position in the vicinity of the position of the horizontal line and to maintain the distant visibility, consequently, it is necessary to set the outside diameter of the light emitting tube to be 4.0 mm or less. Accordingly, it is desirable that the outside diameter of the light emitting tube should be 2.0 to 4.0 mm and preferably 2.5 to 3.5 mm.

As shown in FIGS. 4 and 6, moreover, the amount of a light distribution on this side of a vehicle is insufficient if the length of the light emitting tube is too small (4.0 mm or less), and the temperature of the coldest point of the base part of the electrode is reduced so that an light emission efficiency is decreased and a luminous flux of 2000 lumens or more cannot be obtained if the length of the light emitting tube is too great (16.0 mm or more). Accordingly, it is desirable that the length of the light emitting tube should be 6.0 to 14.0 mm and preferably 8.0 to 12.0 mm.

As shown in FIG. 6, if the size of the cylindrical light emitting tube is specified by the dimension ratio d/L of the outside diameter d to the whole length L, it is desirable that the d/L should range from 0.2 to 0.5 in order to obtain a stable luminous flux of 2000 lumens or more which has an excellent visibility. A decimal value in the table of FIG. 6 indicates a value of the d/L which is represented as ◯ when the stable luminous flux of 2000 lumens or more is obtained and as X when the same luminous flux is not obtained.

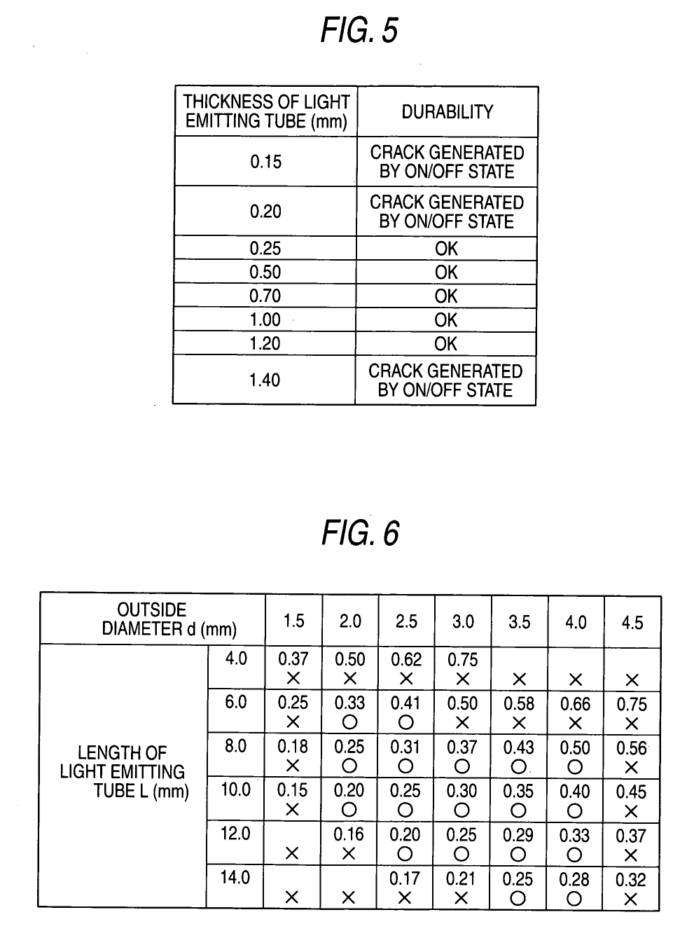

As shown in FIG. 5, moreover, in the case in which the thickness of the light emitting tube is too small (0.20 mm or less) or too great (1.40 mm or more), a crack is generated on the tubular wall. Therefore, it is desirable that the thickness of the light emitting tube should range from 0.25 to 1.20 mm in which the crack is not generated on the tubular wall.

In the embodiment, accordingly, the size of the light emitting tube 12 has the d/L set to be 0.2 to 0.5 and a thickness T of the tubular wall is set to be 0.25 to 1.20 mm.

Furthermore, a metal halide to be a light emitting substance is filled in the closed space of the light emitting tube 12. Ceramics rarely react to the filled substance differently from a glass, and it is possible to prevent deterioration with the passage of time, for example, a devitrification phenomenon, a reduction in a luminous flux and a change in a chromaticity which are caused in arc tubes formed of glass.

Since the closed space (discharge space) 12a is small, moreover, an arc A generated between the electrodes 15a and 15b becomes straight in conformity to the tubular wall of the right cylindrical light emitting tube 12 as shown in FIG. 2. The luminance and color of an arc are varied depending on a distance from the center of the arc. Since the light emitting tube 12 constituted by translucent ceramics is milk-white and has the function of diffusing an emitted light, the arc is transmitted through the milk-white light emitting tube so that differences in a luminance and a color are smoothened and the whole light emitting tube 12 emits a light uniformly, thereby obtaining a light emitting section having neither a luminance unevenness nor a color unevenness.

Furthermore, the light emitting tube 12 takes an oblong right cylindrical shape. Therefore, the metal halide filled in the closed space 12a is accumulated like a liquid in the vicinity of the electrodes 15a and 15b in the coldest point position of the light emitting tube 12, that is, in the vicinity of both ends of the light emitting tube 12 as indicated by 13 of FIG. 2. However, the light emitted from the vicinity of both ends of the light emitting tube 12 is not effectively utilized as a distributed light from the beginning, and the yellow light of the metal halide 13 is mixed with a white light in transmission through the milk-white light emitting tube 12, and is diffused and is thus unremarkable. Therefore, there is no problem in the light distribution.

The shroud glass 20 may be constituted by a quartz glass having the function of shielding ultraviolet rays which is doped with TiO₂ or CeO₂, and serves to reliably cut ultraviolet rays in a predetermined wavelength region which is hazardous to a human body from a light emission in the light emitting tube 12 to be a discharge section.

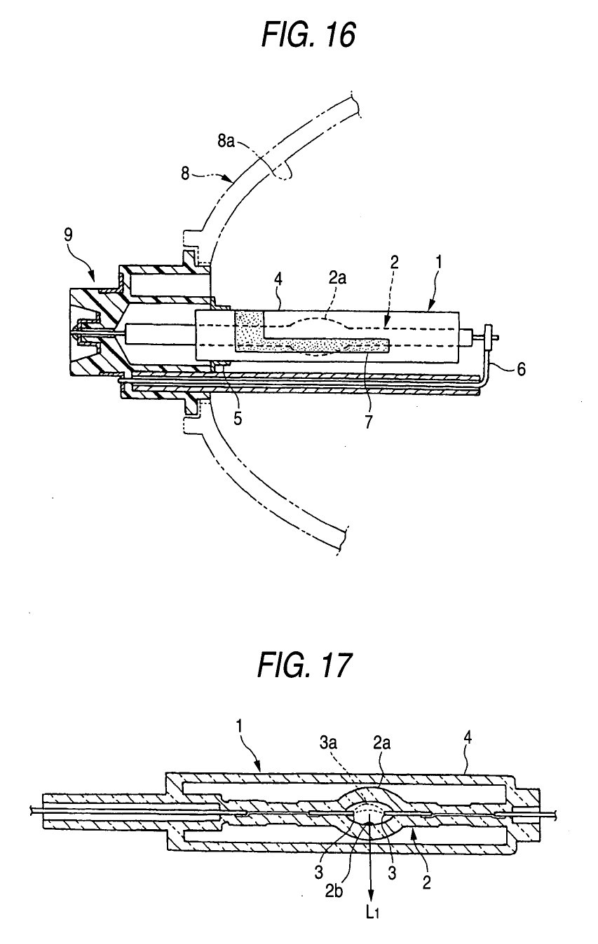

Moreover, the outer peripheral surface of the shroud glass 20 is provided with a shielding film for cut line formation for a low beam (which is not shown, see FIG. 16 illustrating the prior art). For this reason, the light which is emitted from the light emitting tube 12 and is not shielded by the shielding film for cut line formation provided on the shroud glass 20 is reflected by the effective reflecting surface 101 of the reflector 100 as shown in an arrow L2 of FIG. 1 so that a distributed light having a predetermined cut line is formed.

Furthermore, the inside of the shroud glass 20 is brought into a vacuum state or a state in which an inactive gas is filled, and fulfills an adiabatic function for the radiation of a heat transferred from the closed space 12a to be the discharge section and is designed in such a manner that a lamp characteristic is not influenced by a change in an external environment.

In addition, the whole light receiving tube 12 takes a right cylindrical shape and is small-sized. As compared with the related art arc tubes provided with a bulged spherical portion constituting a closed space in a central part in the longitudinal direction of a light emitting tube, the light emitting tube of the present invention can be made thinner corresponding to the bulged spherical portion. Consequently, it is possible to correspondingly reduce the outside diameter of the shroud glass 20 provided to cover the light emitting tube. The shielding film for distributed light formation which is provided on the shroud glass 20 approaches the light emitting tube to be a light emitting section so that a cut line in the distributed light can be clear. In the case in which the tubular diameter of the shroud glass 20 is set to be equal to that in the related art, moreover, the influence of the heat on the shroud glass 20 and the shielding film is lessened so that the standards for the heat resistance of the shroud glass 20 and the shielding film can be relieved corresponding to the separation of the shroud glass 20 from the light emitting tube 12 to be the light emitting section.

The reference numeral 14 denotes a molybdenum pipe serving to seal openings on both ends of the arc tube 11A (the light emitting tube 12) and used for fixing and holding the electrodes 15a and 15b, and the reference numeral 14a denotes a molybdenum metallized layer bonding the light emitting tube 12 to the molybdenum pipe 14. The electrodes 15a and 15b have such a structure that the end faces of a bar-shaped portion 16 formed of tungsten and molybdenum lines 17 to be the lead wires 18a and 18b are opposed to each other and are thus bonded and integrated, and are bonded and sealed to the light emitting tube 12 through the molybdenum pipe 14.

More specifically, the molybdenum pipe 14 is bonded and fixed to both ends of the light emitting tube 12 through metallize bonding, and furthermore, the molybdenum portions (the molybdenum lines 17) of the electrodes 15a and 15b are welded to the pipe 14 so that the sealing portion of the light emitting tube 12 is constituted. The protruded portions of the electrodes 15a and 15b into the closed space 12b are constituted by tungsten which is excellent in a heat resistance and the bonding portions of the electrodes 15a and 15b to the pipe 14 formed of molybdenum are constituted by molybdenum which is compatible with the molybdenum and satisfy both a heat resistance in the discharge light emitting sections of the electrodes 15a and 15b and an airtightness in the sealing portion of the light emitting tube 12.

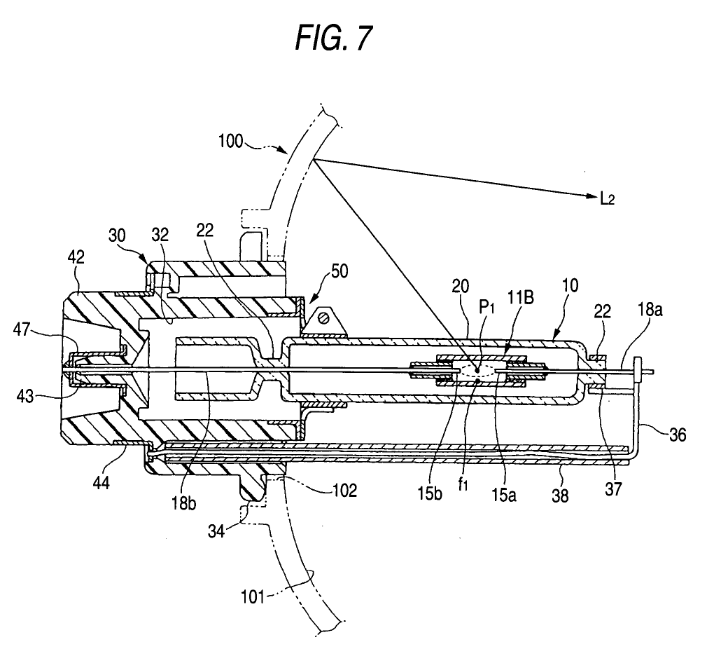

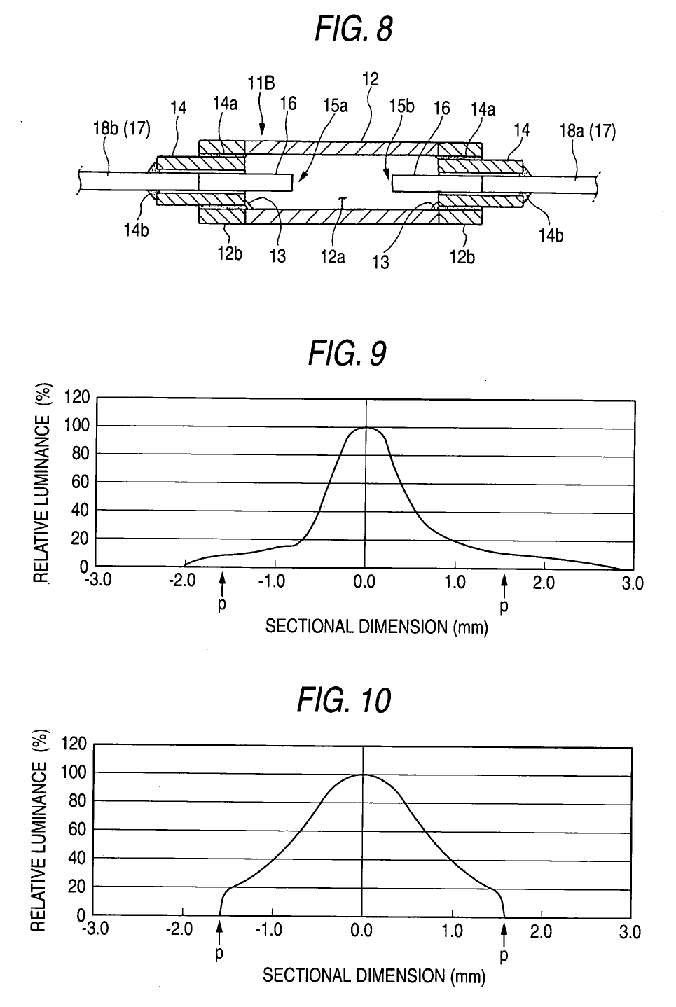

FIGS. 7 and 8 show a second embodiment of the invention, and FIG. 7 is a longitudinal sectional view showing a discharge bulb using an arc tube according to the second embodiment and FIG. 8 is a longitudinal sectional view showing the main part of the arc tube.

In an arc tube 11B according to the second embodiment, a light emitting tube 12 formed of ceramics which constitutes the arc tube 11B has such a structure that an outside diameter d, a length L and a thickness T are entirely equal to those of the light emitting tube 12 formed of ceramics which constitutes the arc tube 11A according to the first embodiment, and furthermore, the parallel ray transmittance of the light emitting tube 12 is 20% or less and the whole ray transmittance of the light emitting tube 12 is 85% or more, and the whole light emitting tube 12 uniformly emits a light and a distributed light having a predetermined cut line is formed without providing a shielding film for cut line formation on a shroud glass 20.

More specifically, it is possible to obtain a whole luminous flux of 2000 lumens or more with the whole ray transmittance of the light emitting tube 12 of 85% or more. Moreover, the brightness and color of an arc are varied depending on a distance from the center of the arc. However, the parallel ray transmittance of the light emitting tube 12 is 20% or less. Therefore, the translucent ceramics are milk-white and have the great function of diffusing an emitted light (a diffusion transmittance is high) and (the light of) the arc is transmitted through a milk-white light emitting tube so that differences in a brightness and a color are fully smoothened and the whole light emitting tube 12 emits an enhanced uniform light , thereby constituting a light emitting section having neither a luminance unevenness nor a color unevenness.

Moreover, a metal halide 13 filled in the light emitting tube 12 is accumulated in the vicinity of the electrode (both ends of the light emitting tube) to be the coldest point position in the cylindrical light emitting tube. The yellow light of the metal halide 13 is diluted in transmission through the milk-white light emitting tube and is diffused during emission and is thus unremarkable. Therefore, there is no problem in the light distribution.

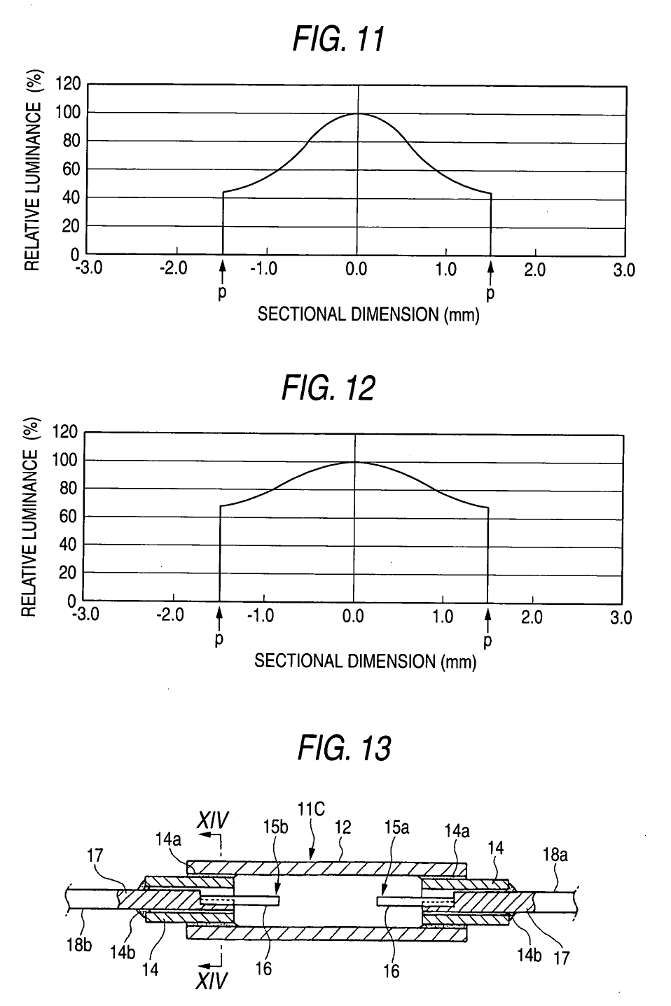

FIGS. 9 to 12 show the luminance distribution characteristics of a light emitting tube formed of ceramics in the case in which the parallel ray transmittance of the light emitting tube is set to be 90%, 50%, 20% and 10%, and an axis of abscissa indicates the sectional dimension of an arc, in which the position of the luminance center of the arc is a zero point (0, 0) and the light emitting tube has an outside diameter of 3.0 mm. As shown in FIGS. 9 and 10, when the parallel ray transmittance of the light emitting tube exceeds 20%, a diffusion transmittance (whole ray transmittance−parallel ray transmittance) is correspondingly reduced and the luminance distribution of the position of the outer peripheral edge of the light emitting tube which is indicated as P is gentle (is not clear) so that the luminance unevenness and color unevenness of the arc are remarkable through the light emitting tube. On the other hand, as shown in FIGS. 11 and 12, if the parallel ray transmittance of the light emitting tube is equal to or less than 20%, the diffusion transmittance is correspondingly increased and the luminance distribution of the position of the outer peripheral edge of the light emitting tube which is indicated as P is sharp (clear) so that the luminance unevenness and color unevenness of the arc are not remarkable through the light emitting tube.

For this reason, in the embodiment, it is possible to form a clear cut line with such a structure that the arc tube 11B is provided with the center of a discharge (the center of a luminance) set in a predetermined position P₁ placed above a focal point f₁ of the effective reflecting surface of a reflector 100 as shown in FIG. 7 without providing a shielding film for cut line formation on the shroud glass 20.

While both ends of the light emitting tube 12 slightly emit a light so that a boundary in the longitudinal direction of the bar-shaped light emitting section is not clear in the arc tube 11A according to the first embodiment, an end region 12b of the light emitting tube 12 provided with a metallized layer 14a is constituted by shielding ceramics having a black color and only a region corresponding to a closed space 12a of the light emitting section 12 emits a light so that the boundary in the longitudinal direction of the bar-shaped light emitting section becomes clear (the contrast of the light emitting section is clear). Consequently, light distribution control can be carried out more easily by an effective reflecting surface 101 of the reflector 100 and a light distribution performance can be further enhanced.

Other portions are the same as those in the first embodiment and have the same designations, and repetitive description thereof will be thus omitted.

As means for making clear the boundary on the end in the longitudinal direction of the bar-shaped light emitting section formed by the light emission of the light emitting tube 12, the end 12a of the light emitting tube 12 is not only constituted by shielding ceramics but may be constituted with the outside of the end of the light emitting tube formed of the translucent ceramics which is subjected to heat-resistant shielding coating.

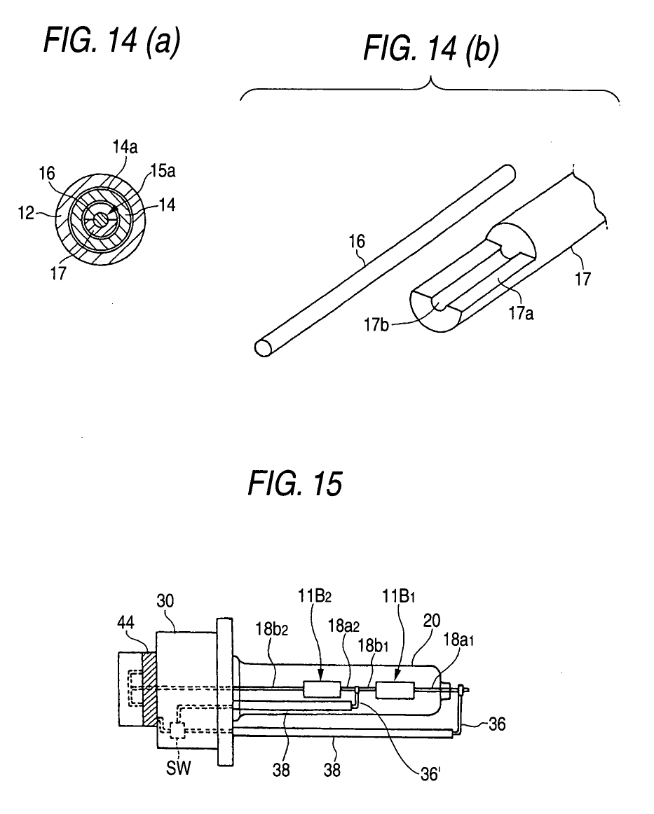

FIGS. 13 and 14 show a third embodiment of the invention, and FIG. 13 is a longitudinal sectional view showing the main part of the embodiment, FIG. 14(a) is a transverse sectional view showing an electrode (a sectional view taken along a line XIV-XIV illustrated in FIG. 13) and FIG. 14(b) is an exploded perspective view showing the electrode.

In an arc tube 11C according to the third embodiment, the tip portion of a molybdenum line 17 constituting a lead wire 18a (18b) is cut through a surface 17a passing through the center of an axis and a concave groove 17b is provided on the center of the cut surface 17a, and a bar-shaped portion 16 formed of tungsten constituting an electrode 15a (15b) is accommodated in the concave groove 17b and is fixed and integrated by spot welding. It is also possible to employ such a structure that the bar-shaped portion 16 formed of tungsten is directly bonded and fixed to the central part of the cut surface 17a by the spot welding without providing the concave groove 17b on the center of the cut surface 17a.

FIG. 15 is a longitudinal sectional view showing a discharge bulb using an arc tube according to a fourth embodiment of the invention.

In the embodiment, two first and second arc tubes 11B1 and 11B2 having the same structure as that of the arc tube 11B according to the second embodiment are arranged in series in front of an insulating plug 30 through first and second lead supports 36 and 36′. A lead wire 18b1 on the rear end side of the front first arc tube 11B1 and a lead wire 18a2 on the front end side of the rear second arc tube 11B2 are supported on the second lead support 36′, a lead wire 18a1 on the front end side of the first arc tube 11B1 is supported on the first lead support 36, and a rear lead wire 18b2 of the second arc tube 11B2 is connected to a cap type terminal (see the designation 47 in FIG. 1) provided on the center of the rear end of the insulating plug 30.

The first lead support 36 and the second lead support 36′ are connected to a belt type terminal 44 provided on the rear end of the insulating plug 30 through a change-over switch SW. It is possible to alternatively employ a configuration in which the first and second arc tubes 11B1 and 11B2 are turned on at the same time and a configuration in which only the second arc tube 11B2 is turned on by the switching of the change-over switch SW.

As is apparent from the above description, according to the first aspect of the invention, the whole light emitting tube which is excellent in durability and heat resistance can emit a light almost uniformly to form a bright and white proper distributed light. In the case in which a distributed light having a predetermined cut line is to be formed as a discharge bulb to be a light source for a reflection type lighting unit for a car, particularly, the arc tube is provided to shift the center of a discharge (the center of a luminance) from the focal point of the effective reflecting surface of the reflector. Consequently, it is possible to form a predetermined distributed light having a clear-cut line without providing a shielding section for cut line formation. Thus, a light distribution design can easily be carried out and the structures of the bulb and the lighting unit can also be simplified.

According to the second aspect of the invention, the durability and heat resistance of the light emitting tube are maintained so that the long lifetime of the arc tube can be guaranteed.

According to the third aspect of the invention, the whole light emitting tube which is excellent in a durability and a heat resistance uniformly emits a light and a bar-shaped light emitting section rarely having a luminance unevenness and a color unevenness is obtained. Therefore, it is possible to form a bright and white proper distributed light. In the case in which a distributed light having a predetermined cut line is to be formed as a discharge bulb to be a light source for a reflection type lighting unit for a car, particularly, the arc tube is provided to shift the center of a discharge (the center of a luminance) from the focal point of the effective reflecting surface of the reflector. Consequently, it is possible to form a predetermined distributed light having a clear-cut line without providing a shielding section for cut line formation. Thus, a light distribution design can easily be carried out and the structures of the bulb and the lighting unit can also be simplified.

what is claimed is:

1. An arc tube for a discharge bulb in which both ends of a light emitting tube inserting electrodes respectively are sealed and a closed space having the electrodes opposed to each other and filled with a light emitting substance with a rare gas for starting is provided in the light emitting tube, wherein the light emitting tube comprises translucent ceramics formed substantially cylindrically and has a ratio d/L of an outside diameter d to a whole length L ranging from 0.2 to 0.5.

2. The arc tube for a discharge bulb according to claim 1, wherein the light emitting tube has a thickness of 0.25 mm to 1.2 mm.

3. An arc tube for a discharge bulb in which both ends of a light emitting tube inserting electrodes respectively are sealed and a closed space having the electrodes opposed to each other and filled with a light emitting substance together with a rare gas for starting is provided in the light emitting tube, wherein the light emitting tube comprises translucent ceramics formed substantially cylindrically and has a parallel ray transmittance of 20% or less and a whole ray transmittance of 85% or more.

4. An arc tube for a discharge bulb comprising a light emitting tube formed using translucent ceramics and having a ratio d/L of an outside diameter d to a whole length L ranging from about 0.2 to about 0.5.

5. The arc tube for a discharge bulb according to claim 4, wherein the light emitting tube has a substantially cylindrical shape.

6. An arc tube for a discharge bulb comprising a light emitting tube, formed in a substantially cylindrical shape using translucent ceramics and having a parallel ray transmittance of 20% or less and a whole ray transmittance of 85% or more.
